(19) United States
(12) Patent Application Publication
(10) Pub. No.: US 2014/0344131 A1
(43) Pub. Date: Nov. 20, 2014

(54) Alternative Risk Transfer Platform

(71) Applicant: Hugh J. Sloan, III, San Ramon, CA (US)

(72) Inventor: Hugh J. Sloan, III, San Ramon, CA (US)

(21) Appl. No.: 14/259,029

(22) Filed: Apr. 22, 2014

Related U.S. Application Data
(60) Provisional application No. 61/814,753, filed on Apr. 22, 2013.

(51) Int. Cl. G06Q 40/06

(52) U.S. Cl. CPC G06Q 40/06; G06Q 40/08
USPC 705/35

(57) ABSTRACT

A platform for alternative risk transfer (ART), comprising a risk database configured to store risk data, a participant database configured to store a registry of ART participants, a ratings database configured to store ratings data regarding the risk data and the ART participants, and a risk crossing network database configured to store loss financing offers submitted by the ART participants, each of the loss financing offers being associated with one or more criteria. The ART platform can be used to match loss financing offers from different ART participants, which can then transfer risk according to the terms of the matched loss financing offers.

### CLAIM OF PRIORITY

This application claims priority under 35 U.S.C. §119(e) from earlier filed U.S. Provisional Application Ser. No. 61/814,753, filed Apr. 22, 2013, by Hugh J. Sloan, III, the entirety of which is incorporated herein by reference.

### BACKGROUND

1. Field of the Invention

The present disclosure relates to risk management, particularly a platform for matching and facilitating alternative risk transfer between participants.

2. Background

Risk management strategies often involve transferring the risk of loss of particular events from one party to another party. In some situations risk can be contractually shifted from one party to another, such as when an insurance company contracts to have a re-insurer take on some of the risk associated with one or more of the insurance policies it administers.

However, besides traditional insurance and reinsurance transactions, alternative risk transfer (ART) techniques can be used to transfer risk between parties. For example, ART can involve the transfer of risk back and forth between insurance markets and capital markets. In some of these situations, risk can be securitized to create risk instruments that can then be traded or invested in similarly to traditional securities.

FIG. 1 depicts a non-limiting example of an implementation of a catastrophe bond (CAT bond), a type of ART risk instrument that can be used to transfer the risk of the occurrence of a certain particular catastrophic event, such as a hurricane, from one party to one or more other parties. A risk-holding party 100 that holds the risk of a particular catastrophic event, such as an insurer that has issued an insurance policy regarding that catastrophic event, can sponsor a special purpose vehicle 102. The special purpose vehicle 102 can be funded with principal from investors 104, and the principal funds can be held in trust 106 for the duration of the CAT bond.

During the duration of the CAT bond, the risk-holding party 100 that originally held the risk of the occurrence of the catastrophic event can pay premiums to the special purpose vehicle 102 to cede some or all of its risk, effectively obtaining re-insurance. If the catastrophic event occurs, the original risk-holder's exposure due to the catastrophic event can be covered by claim payments from the special purpose vehicle's trust funds.

The CAT bond can therefore transfer the risk of the occurrence of the catastrophic event from the original risk-holding party 100 to the investors 104. During the duration of the CAT bond, the investors 104 can receive interest on the principal they invested, with the principal additionally being returned to them at the end of the CAT bond's duration if the catastrophic event has not occurred. However, the investors 104 take on risk because if the catastrophic event does occur, they may lose some or all of their principal and future interest payments when the special purpose vehicle's funds are paid out to the original risk-holding party 100 as claim payments. In some situations, such as when the occurrence of the catastrophic event is perceived as unlikely, investment in the CAT bond can be attractive to investors 104 because it may be likely to provide a good return without being tied to the volatility of normal capital markets, and yet the investment in the CAT bond can be an asset that can be traded similarly to regular securities.

ART has traditionally been performed between parties with pre-existing relationships, or through one-way blind auctions. For instance, private networks and dark pools have been used to set up and/or trade insurance-based securities or interests in other ART risk instruments without opening up such transactions to the public, or to keep information about these risk instruments and transactions private. There has been little opportunity for parties to find each other over an open system to transfer risk, and no centralized data feed open to the public that would allow informed evaluation of ART risk instruments.

What is needed is an ART Platform that provides an electronic marketplace that can match parties to transfer risk. The ART Platform should track information about users, risk data, and loss financing offers, and can make that information more generally available to any potential transferor or transferee of risk. The ART Platform should also be able to track offers to offload risk and take on risk, such that matched users can transfer risk according to the terms of the offers.

### BRIEF DESCRIPTION OF THE DRAWINGS

FIG. 1 depicts an exemplary embodiment of a structure implementing an alternative risk transfer (ART) risk instrument, such as a catastrophe (CAT) bond.

FIG. 2 depicts a system by which an ART Platform matches ART Participants to transfer risk.

FIG. 3 depicts an exemplary embodiment of an ART Platform.

FIG. 4 depicts exemplary interactions to transfer risk between a chain of ART Participants.

FIG. 5 depicts a first exemplary method of using an ART Platform.

FIG. 6 depicts a second exemplary method of using an ART Platform.

FIG. 7 depicts an exemplary embodiment of a computer system.

### DETAILED DESCRIPTION

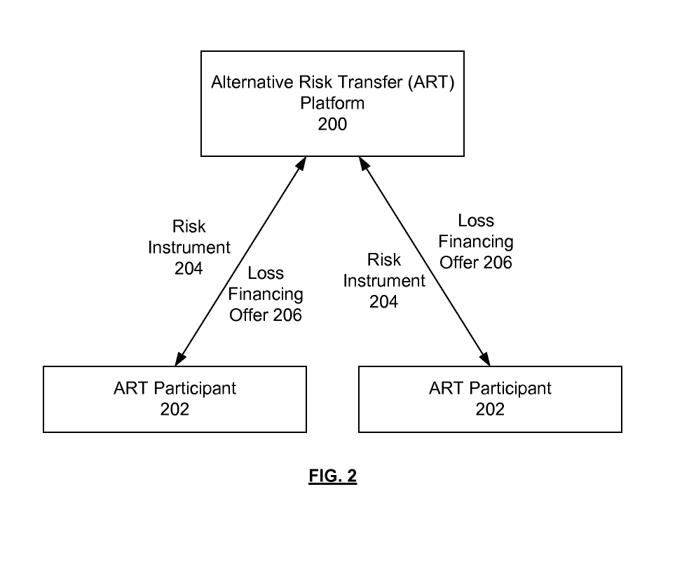

FIG. 2 depicts an embodiment of a system in which an Alternative Risk Transfer (ART) Platform 200 can be used to match ART Participants 202 and transfer risk to and from ART Participants 202 through risk instruments 204 and loss financing offers 206.

ART Participants 202 can be actual or potential transferees and/or transferors of risk, such as entities, agents, brokers, or any other parties or users interested in transferring risk. Risk can be the potential of financial or other burdens associated with recovery from particular events should they occur.

In some embodiments and/or situations, an ART Participant 202 can be an entity, such as an insurance company, reinsurance company, bank, investment bank, hedge fund administrator, pension fund administrator, mutual fund administrator, capital market group, or any other entity, group, company, investor, vehicle or user. In some embodiments, an ART Participant 202 can sponsor or set up another specialized ART Participant 202 to manage a risk instrument 204. By way of a non-limiting example, an ART Participant 202 such as an insurance company can sponsor a product vehicle, such as a captive insurance company, risk retention group, special purpose vehicle, Bermuda transformer, or insurer-owned capital market subsidiary, to manage a risk instrument 204. In other embodiments and/or situations, an ART Participant 202 can be an agent or representative of an entity, such as a corporate risk manager representing an entity.

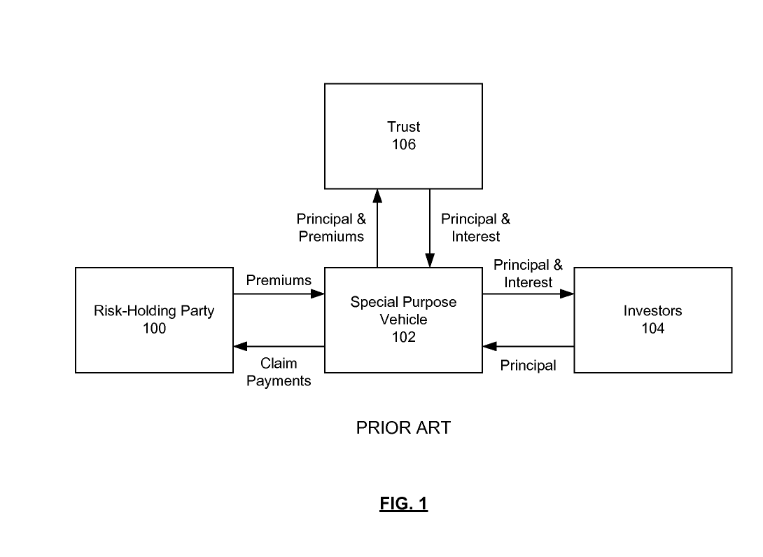

Risk instruments 204 can be alternative risk products or services that can be used by one ART Participant 202 to transfer risk to one or more other ART Participants 202 that desire to take on risk. Risk instruments 204 can be insurance contracts, reinsurance contracts, multi-risk products, insurance-linked securities, contingent capital structures, insurance derivatives, catastrophe bonds, sidecars, or any other alternative risk product or service, or combinations of alternative risk products and/or services. By way of a non-limiting example, a risk instrument 204 can be a catastrophe (CAT) bond, as shown in FIG. 1. Risk instruments 204 can be within one or more instrument classes, such as liability, workers compensation, health, property, and life insurance or annuities. Some risk instruments 204, such as a CAT bond, can have an indemnity-based trigger that initiates payment to one party or another based on the occurrence of an event.

As mentioned above, in some embodiments and/or situations, a specialized ART Participant 202 can be formed or sponsored by one or more other ART Participants 202 to create and/or manage a risk instrument 204, such as a special purpose vehicle 102 that manages a CAT bond as shown in FIG. 1. In other embodiments and/or situations, an existing ART Participant 202 can manage a risk instrument 204.

Loss financing offers 206 can be offers by ART Participants 202 to transfer risk to other ART Participants 202 via risk instruments 204. Loss financing offers 206 can be bids, quotes, or offers to trade risk instruments 204, trade interests in risk instruments 204, take on risk by investing in risk instruments 204, cede risk through risk instruments 204, and/or any other manner of transferring risk. In some embodiments, loss financing offers 206 can be actual bids to offload or accept risk. In other embodiments, loss financing offers 206 can be quotes describing potential offers regarding risk that an ART Participant 202 would be willing to make if one or more other ART Participants 202 are found through the ART Platform 200 that would be willing to accept the loss financing offer 206.

Loss financing offers 206 can be submitted or accepted through the ART Platform 200 by ART Participants 202. The ART Platform 200 can find loss financing offers 206 that each match one or more criteria to pair one or more ART Participants 202 that have offered to offload a particular type of risk with one or more ART Participants 202 that have offered to take on that type of risk. The ART Participants 202 can then transfer risk through a new or existing risk instrument 204, by selling or trading risk instruments 204, or through any other desired manner of transferring risk.

In some embodiments, elements of the ART Platform 200 can be accessed by ART Participants 202 through a user interface provided by an application or website. By way of non-limiting examples, users can interact with the ART Platform 200 through a native application or a third party application that interfaces with the ART Platform 200 through an application programming interface (API) provided by the ART Platform 200. In some embodiments, the ART Platform 200 can have standard user interface elements shared between native applications and third party applications, while in other embodiments third party applications can provide their own user interface elements. In alternate embodiments, data from the ART Platform 200 can be queried and/or retrieved by a native or third party application, website, or other interface in any other fashion through an API.

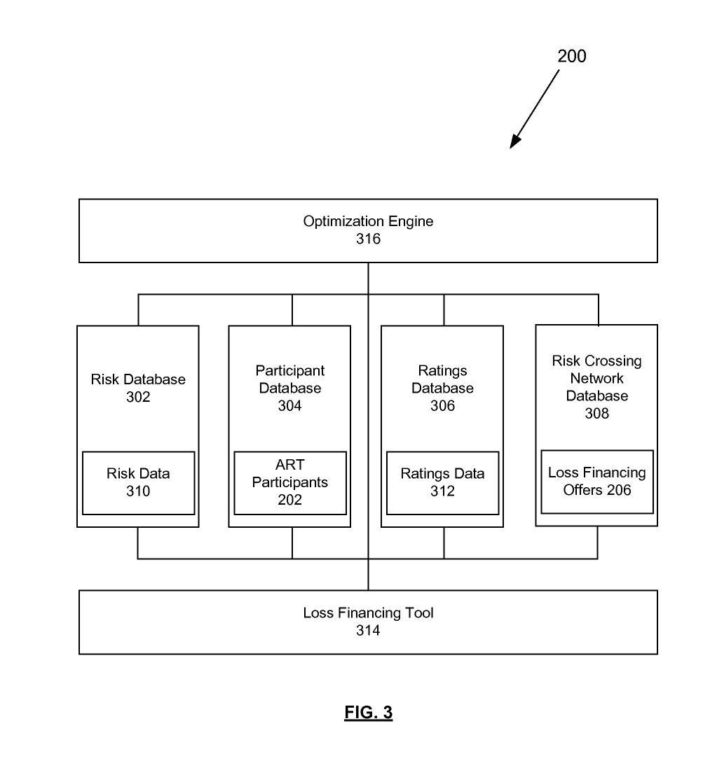

FIG. 3 depicts an embodiment of an ART Platform 200. An ART Platform 200 can comprise one or more databases, such as a risk database 302, a participant database 304, a ratings database 306, and/or a risk crossing network database 308. In some embodiments, each database can be stored separately on one or more servers located together or in different locations. In other embodiments, two or more of the databases shown in FIG. 3 can be combined or be sub-parts of a larger database.

The risk database 302 can be a database that stores instances of risk data 310. Risk data 310 can describe any type of information related to risk management and/or risk transfer, such information related to risk instruments 204, classes of risk instrument 204, transfers of risk instruments 204, ART Participants 202, product vehicles, regulatory schemes, accounting principles or standards, insurance markets, capital markets, ratings agencies, parametric transactions, ART market indices, indemnity triggers, Insurance Services Office Inc. (ISO) property claims, modeled loss, weather derivatives, industry loss, catastrophe (CAT) bond swaps, CAT bond pricing, property and casualty securitizations, events, basis risk, risk portfolios, transactions, claims, indices, pricing, and/or any other type of information. By way of a non-limiting example, an instance of risk data 310 can describe information about a regulatory or accounting scheme used in ART, such as Basel I, Basel II, Basel III, Solvency I, Solvency II, Statutory Accounting Principles (SAP), Generally Accepted Accounting Principles (GAAP), or International Financial Reporting Standards (IFRS).

The risk database 302 can store content records associated with one or more instances of risk data 310. Content records can be data files such as text, images, audio, video, HTML, XML, JSON, PDF, web applications, software, and/or any other type of data file. In some embodiments, a content record can be a Uniform Resource Identifier (URI), such as a Uniform Resource Locator (URL), that points to data stored outside the risk database 302.

In some embodiments and/or situations, instances of risk data 310 in the risk database 302 can be entered, linked to or uploaded by ART Participants 202. In other embodiments and/or situations, instances of risk data 310 can be pulled automatically from external web sites, networks, or databases. By way of a non-limiting example, information can be imported or translated into the risk database 302 from other networks or websites, such as Google®, Facebook®, Yahoo!®, Craigslist®, or A.M. Best®, or offline information sources such as trade publications or ratings guides. By way of non-limiting examples, information from other sources can be transferred to the risk database 302 using HTML/XML/JSON over HTTP/HTTPS, REST, web interfaces, data files, TCP/IP protocols, wireless protocols, scanning, and/or any other method of electronic or data communication.

In some embodiments, the risk database 302 can be organized similar to a class inheritance structure used in object oriented programming models, with definitions for each class, or be organized similar to the XML language, in which instances of risk data 310 has elements and attributes. By way of a non-limiting example, an instance of risk data 310 stored in the risk database 302 can generally describe a particular risk instrument 204, with other linked sub-instances of risk data 310 describing more specific attributes about that particular risk instrument 204. In other embodiments, the risk database 302 can have any other desired organizational structure.

The participant database 304 can comprise a registry of ART Participants 202. The participant database 304 can indicate information about each ART Participant 202, such as its name, contact information, relationships or associations with other ART Participants 202, which services, products, and/or types of risk data 310 it provides, and/or any other type of information. By way of a non-limiting example, the participant database 304 can track the relationships between a specialized ART Participant 202, such as a special purpose vehicle 102, an ART Participant 202 that set up or sponsored the specialized ART Participant 202, and any ART Participants 202 that have invested in risk instruments 204 managed by the specialized ART Participant 202. In some embodiments, the participant database 304 can link the identities of registered ART Participants 202 to user accounts on other networks.

In some embodiments, the participant database 304 can further store historical information about transactions undertaken by particular ART Participants 202. By way of a non-limiting example, the participant database 304 can track past loss financing offers 206 submitted or accepted by ART Participants 202, transfers of risk completed by ART Participants 202 through the ART Platform 200, and/or any other historical data.

The ratings database 306 can store ratings data 312 associated with risk data 310, risk instruments 204, and/or ART Participants 202. Ratings data 312 can be ratings, reviews, and/or other actions about particular instances of risk data 310, risk instruments 204 and/or ART Participants 202. In some embodiments and/or situations, the ratings data 312 can have been entered into the ratings database 306 by ART Participants 202. In other embodiments and/or situations, ratings data 312 can be pulled by the ART Platform from external networks or databases. Each instance of ratings data 312 can be tagged with the date and time the ratings data 312 was submitted, where the ratings data 312 originated, such as which ART Participant 202 submitted the ratings data 312, and/or any other metadata or other information.

Ratings data 312 about instances of risk data 310 can include ratings or reviews of the quality of the risk data 310, the provider of the risk data 310, the applicability of the risk data 310 to certain risk instruments 204, and/or any other information. By way of a non-limiting example, a ratings agency can submit ratings data 312 about risk data 310 pertaining to a particular risk instrument 204, such as a rating of the structure of a CAT bond or a percentage of the chances of the occurrence of a risk event tied to the risk instrument 204.

Ratings data 312 about another ART Participant 202 can include a submitting ART Participant's rating of their past experience dealing with the rated ART Participant 202. By way of non-limiting examples, ART Participants 202 can be rated on how they performed on one or more tasks, including underwriting, risk management, loss or claims adjustment processes, and/or any other function.

In some embodiments, an ART Participant 202 can submit ratings data 312 to the ratings database 306 with an application that is native to the Art Platform 200. In other embodiments, a third party application can receive ratings data and submit the ratings data to the ratings database 306 through an API.

In some embodiments, recent ratings data 312 can be weighted more heavily than older ratings data 312. As will be discussed below, in some situations ratings data 312 can be used when matching ART Participants 202 through loss financing offers 206 to assist in optimizing risk transfers, and more recent ratings data 312 that may be more accurate than outdated ratings data 312 can be given greater weight. In alternate embodiments, ratings data 312 can be weighted equally regardless of the date the ratings data 312 was submitted or imported into the ratings database 306.

Some or all of the data in the risk database 302, participant database 304, ratings database 306, and/or risk crossing network database 308 can be open to the public, or be available to any ART Participant 202 that has registered to use the ART Platform 200. In some embodiments, historical trends, statistics, or other metrics or information derived from the data stored in the ART Platform 200 can be provided to users. This information can be accessed directly through an application native to the ART Platform 200, or via an external application or website through an API. Users of the ART Platform 200 can thus use the information accessible through ART Platform 200 to evaluate other ART Participants 202 and/or risk instruments 204 to assess existing or potential risk investments, portfolios, exposures, or transactions. By way of non-limiting examples, users can evaluate the risk data 310 and ratings data 312 associated with a risk instrument 204 and/or the ratings data 312 of an ART Participant 202 to determine potential exposure, compare risk models against basis risk or events, or to perform cost-benefit analyses on risk instruments 204. As another non-limiting example, risk data 310 can be retrieved from the ART Platform 200 by an external user or application through an API to capture and store data streams for risk instruments 202, as classified by accounting principles such as IFRS, SAP, or GAAP. As yet another non-limiting example, a user can retrieve or query risk data 310 to calculate premium indexes, claims indexes, and/or retention rates for regulatory schemes such as Solvency I, Solvency II, Basel I, or Basel II.

The risk crossing network database 308 can store loss financing offers 206 submitted by ART Participants 202. Loss financing offers 206 can be offers to offload risk or to take on risk. In some embodiments, loss financing offers 206 can offer to transfer risk via a new or existing risk instrument 204.

In some embodiments, ART Participants 202 can use a loss financing tool 314 to submit loss financing offers 206 to the risk crossing network database 308, and/or search for loss financing offers 206 already stored in the risk crossing network database 308. The loss financing tool 314 can be an integrated part of the ART Platform 200, or can be a standalone application, website, or other interface that interacts with the ART Platform 200. The loss financing tool 314 can have access to the data stored by the ART Platform 200, such as the risk database 302, participant database 304, ratings database 306, and risk crossing network database 308, as well as other data stored outside the ART Platform 200. In some embodiments and/or situations, the loss financing tool 314 can bundle individual loss financing offers 206 into larger composite loss financing offers 206 from one or more ART Participants 202, while in other embodiments each loss financing offer 206 can remain separate within the risk crossing network database 308. In some embodiments, any other tool, application, website or interface can be used to submit or retrieve loss financing offers 206.

Each loss financing offer 206 can be associated with one or more criteria. In some embodiments, the criteria can be similar to or be associated with instances of risk data 310. The criteria of a loss financing offer 206 can specify information about the submitting ART Participant 202, a description of the risk products or services being offered, the level and type of coverage being sought, terms and conditions of the offer, price or loss financing, time and availability, location constraints, time constraints, quota information, requests for proposals (RFPs), requests for quotes (RFQ), and/or any other attributes of the loss financing offer 206. By way of non-limiting examples, a loss financing offer 206 can be associated with criteria specifying that the submitting ART Participant 202 desires to offload a particular type of risk for a particular coverage amount through a particular type of risk instrument 204, or desires to trade an existing interest in a risk instrument to a different ART Participant 202. Similarly, other loss financing offers 206 can be associated with criteria indicating that the submitting ART Participant 202 desires to take on risk via a particular type of risk instrument 204, or is willing to invest a certain amount of capital in a risk instrument 204 that falls into a particular class of risk instrument 204.

In some embodiments, a loss financing offer 206 and its criteria can be entered manually by an ART Participant 202. In some embodiments, the loss financing tool 314 or a module can translate manually entered data into criteria formatted for a loss financing offer 206. In some embodiments, the loss financing tool 314 can interface with one or more modules or plug-ins that can recommend criteria for loss financing offers 206, compute derived criteria based on other types of criteria or risk data 310, translate or make any other type of recommendation for criteria, and/or fill in criteria for loss financing offers 206. By way of a non-limiting example, a module can present a series of sliders regarding various offer preferences that an ART Participant 202 can move to select preferences, and the module can convert the chosen preferences entered via the sliders into criteria for the loss financing offer 206. In some embodiments, the modules can be provided by a third party, and can interact with the loss financing tool 314 and other parts of the ART Platform via an API. In other embodiments, loss financing tool 314 can itself recommend, compute, or translate criteria for a loss financing offer 206.

In other embodiments, the loss financing tool 314, an optimization engine 316, and/or a module can automatically fill in any criteria for a loss financing offer 206 based on information stored in the ART Platform's databases, or in any other external databases or sources of information that can be accessed by the ART Platform 200. In some embodiments, historical data tracked by the ART Platform 200 can be displayed to ART Participants 202 regarding which kinds of loss financing offers 206 have been previously accepted by ART Participants 202, and/or the loss financing tool 314 can suggest criteria historically found more favorable, such that loss financing offers 206 that include criteria more likely to be accepted by other ART Participants 202 can be constructed and submitted.

In some embodiments, information regarding ART Participants 202 and loss financing offers 206 can be communicated by the ART Platform 200 to other networks or websites, to publicize the loss financing offers 206 and invite non-registered ART Participants 202 to use the ART Platform 200 to accept loss financing offers 206. In other embodiments, only registered ART Participants 202 can view, search for, and/or accept loss financing offers 206 listed in the risk crossing network database 308.

In some embodiments, an ART Participant 202 can use the loss financing tool 314 and/or an optimization engine 316 to manually search the risk crossing network database 308 for loss financing offers 206, or be presented with a list or table of current loss financing offers 206 that can be accepted. In some embodiments, the identity of the ART Participant 202 that submitted a loss financing offer 206 can be hidden initially, and be revealed upon the consent of the submitting ART Participant 202. In other embodiments, the identity of the ART Participant 202 that submitted a loss financing offer 206 can be visible.

In other embodiments, an optimization engine 316 can compare the criteria associated with each loss financing offer 206 stored in the risk crossing network database 308 to find potential matches. By way of a non-limiting example, if one loss financing offer 206 includes criteria that indicates the submitting ART Participant 202 desires to offload a certain level of a particular type of risk for a particular price, and the optimization engine 316 finds another loss financing offer 206 that indicates another ART Participant 202 desires to take on that type of risk for a price within a price range that includes the price indicated in the offloading ART Participant's loss financing offer 206, the optimization engine 316 can notify each ART Participant of the matching loss financing offers 206. The matched ART Participants 202 can then choose whether or not to go ahead with a transaction to transfer risk according to the terms of the loss financing offer 206. If the risk transfer is to occur through a product vehicle that administers a risk instrument 204, the ART Participants 202 can choose an existing specialized ART Participant 202 to administer the risk instrument 204 or sponsor and set up a new specialized ART Participant 202 to manage the risk instrument 204. In other situations, risk instruments 204 can be traded directly through the ART Platform 200.

In some embodiments, the optimization engine 316 can take ratings data 312 from the ratings database 306 into account when matching criteria of different loss financing offers 206. By way of a non-limiting example, the optimization engine 316 can present a particular ART Participant 202 with a ranked list of loss financing offers 206 that match criteria of the ART Participant's own loss financing offer 206, with the list ranked according to ratings data 312 associated with the listed loss financing offers 206 or submitting ART Participants 202, such that a loss financing offer 206 submitted by an ART Participant 202 that has been rated poorly or below a predefined threshold can be presented below other loss financing offers 206 associated with more highly rated risk data 310 or ART Participants 202.

As mentioned above, in some embodiments recent ratings data 312 can be weighted more heavily than older ratings data 312 when evaluating matches between the criteria of loss financing offers 206 or ranking matching loss financing offers 206. In other embodiments, the age of the ratings data 312 can be ignored by the optimization engine 316.

In addition to searching and/or matching loss financing offers 206 according to the criteria of the loss financing offers 206, in some embodiments other types of searching parameters or preferences can be used by the optimization engine 316 when sorting or searching for loss financing offers 206, such as data stored on one or more internal or external databases accessible by the ART Platform 200. In some embodiments the searching parameters can be predetermined, while in other embodiments ART Participants 202 can set searching parameters, preferences, or criteria in a user preferences menu. Such searching parameters can include aggregate ratings data 312 associated with the ART Participant 202 that submitted a loss financing offer 206, the submitting ART Participant's geographic location or jurisdiction, the date and time when the loss financing offer 206 was submitted, how many times the same or similar loss financing offer 206 has been shown to the ART Participant 202 during a period of time, the likelihood of the searching ART Participant 202 accepting the loss financing offer 206 based on historical patterns, or any other type of data. By way of a non-limiting example, the optimization engine 316 can track loss financing offers 206 accepted and/or submitted by a particular ART Participant 202, and calculate a score that approximates or strongly correlates with the likelihood that the ART Participant 202 will accept a certain type of loss financing offer 206 in the future using a moving average, Poisson model, or other metric, and rank loss financing offers 206 on a list of matches lower if there is a calculation suggesting that the ART Participant 202 is not likely to accept them.

In some embodiments, information about the searching parameters or historical trends regarding ART Participants 202 can be openly accessible to other ART Participants 202, such that the information can be used to construct loss financing offers 206 that might be more appealing for particular ART Participants 202. By way of a non-limiting example, if one ART Participant 202 is informed through the ART Platform 200 that another ART Participant 202 has statistically not historically accepted loss financing offers 206 of a certain type, the first ART Participant 202 can choose to submit a different loss financing offer 206 with different criteria that may be more acceptable to the second ART Participant 202.

In some embodiments and/or situations, ART Participants 202 can be notified when matching loss financing offers 206 are found, and the ART Participants 202 can then decide whether or not to go forward with the risk transfer transaction. In other embodiments and/or situations, the ART Platform 200 can automatically implement risk transfers between matched ART Participants according to the terms of the loss financing offers 206 they previously submitted and/or user settings. By way of a non-limiting example, when the optimization engine 316 searches for existing loss financing offers 206 that match the criteria of a newly submitted loss financing offer 206, the most highly ranked matching loss financing offer 206 can be automatically accepted and risk can be transferred between ART Participants 202 according to the terms of the matched loss financing offers 206.

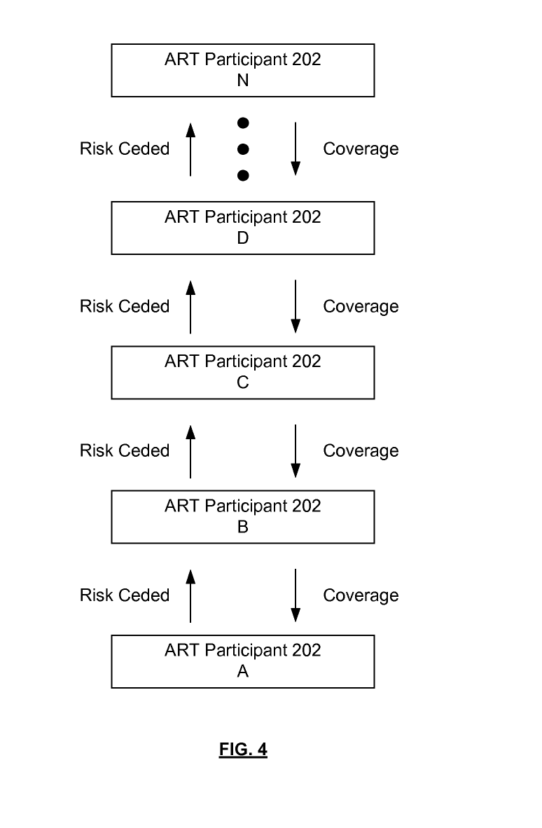

In some embodiments, the ART Platform 200 can be used to optimize prices for risk coverage. FIG. 4 depicts an exemplary example where a chain of ART Participants 202 can be identified through the ART Platform 200 to determine whether particular types of risk can be transferred to other ART Participants 202. For example, an ART Participant 202, such as an insurance company that is considering providing insurance coverage to an entity, can use the ART Platform 200 to determine up front if a second ART Participant 202 is willing to take on some or all of the risk associated with the potential insurance policy, and at what price, such as by determining if the second ART Participant 202 has submitted a loss financing offer 206 indicating a willingness to take on that type of risk. Similarly, the second ART Participant 202 taking on some of the risk can use the ART Platform 200 to determine if a third ART Participant 202 would be willing to take on a portion of the risk that the second ART Participant 202 takes on, and at what price. This process can continue up the line, such that multiple ART Participants 202 in a chain can be matched and their potential investment amounts or prices, and amounts of risk to be transferred between each, can be known even before the base insurance policy is issued by the first ART Participant 202. This can reduce uncertainty regarding the amount of risk taken on by each ART Participant 202 in the chain, allowing prices to be reduced at each level and assisting in optimizing the transfer of risk.

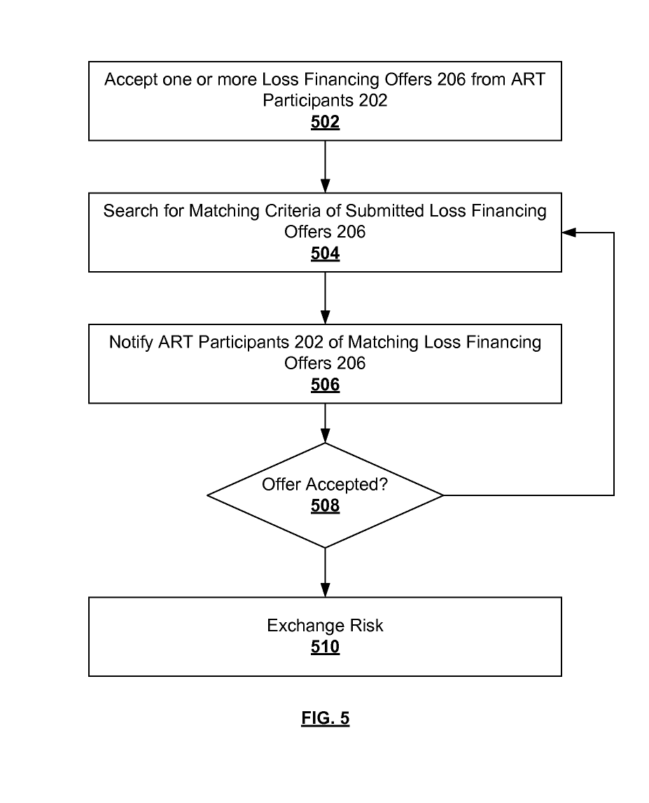

FIG. 5 depicts a first exemplary method for using the ART Platform 200 to transfer risk. At step 502, one or more ART Participants 202 can submit loss financing offers 206 to the risk crossing network database 308 using the loss financing tool 314. The ART Participant can choose to initially submit a general loss financing offer 206 that it believes might be acceptable to multiple other ART Participants 202, or can use the data retrievable through the ART Platform 200 to construct targeted loss financing offers 206 that are tailored toward the searching preferences or historical transactional data of specific ART Participants 202. In some embodiments, existing loss financing offers 206 can be edited to change their criteria. By way of a non-limiting example, in some embodiments the ART Platform 200 can inform an ART Participant 202 over time how other ART Participants 202 have reacted to their loss financing offers 206 in various contexts, such that the loss financing offers 206 can be adjusted to include criteria more likely to be accepted.

At step 504, after the loss financing offer 206 has been submitted, the optimization engine 316 can search the risk crossing network database 308 for previously-submitted loss financing offers that match one or more criteria defined by the new loss financing offer 206.

At step 506, once any matches are found, the ART Platform 200 can notify the ART Participants 202 that submitted the matching loss financing offers 206. In some embodiments, when multiple matches are found, the matches can be ordered in a ranked list according ratings data 312 and/or searching parameters specified by the ART Participants 202.

After being notified of potential matches, the ART Participants 202 can then decide whether or not to move forward with a risk transfer transaction according to the terms of their respective loss financing offers 206. If the ART Participants 202 reach an agreement to transfer risk, the offers can be accepted at step 508 and the risk can be transferred during step 510. In some embodiments and/or situations, a new specialized ART Participant 202 can be sponsored and/or set up to manage a risk instrument 204 that can effectuate the risk transfer. By way of a non-limiting example, a special purpose vehicle 102 can be set up to manage a CAT bond to transfer risk from the original risk-holding party to one or more investors, as shown in FIG. 1. In other embodiments, the matched ART Participants 202 can directly trade or transfer risk instruments 204, or transfer risk in any other desired manner.

If the ART Participants 202 do not reach an agreement to transfer risk according to the matched loss financing offers 206 at step 508, the ART Platform 200 can return to step 504 to continue searching for other matching loss financing offers 206.

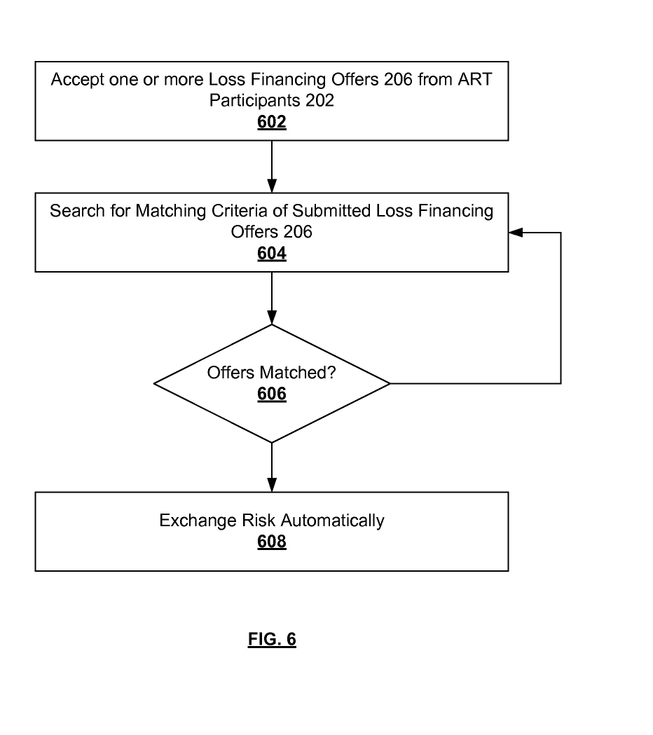

FIG. 6 depicts a second exemplary method for using the ART Platform 200 to transfer risk. At step 602, similar to step 502, one or more ART Participants 202 can submit loss financing offers 206 to the risk crossing network database 308 using the loss financing tool 314.

At step 604, after the loss financing offer 206 has been submitted, the optimization engine 316 can search the risk crossing network database 308 for previously-submitted loss financing offers that match one or more criteria defined by the new loss financing offer 206.

At step 606, if matching loss financing offers have been found, the ART Platform 200 can move to step 608 to automatically transfer risk through the ART Platform 200 according to the terms of their respective matching loss financing offers 206. If multiple matches were found during step 604 and 606, the most highly ranked loss financing offers 206 and/or loss financing offers 206 that best matched the searching parameters of each ART Participant 202 can be matched and a risk transaction can be undertaken automatically according to the best matched loss financing offers 206. If no matches were found during step 604 and step 606, the ART Platform 200 can return to step 604 to continue searching for matching loss financing offers 206.

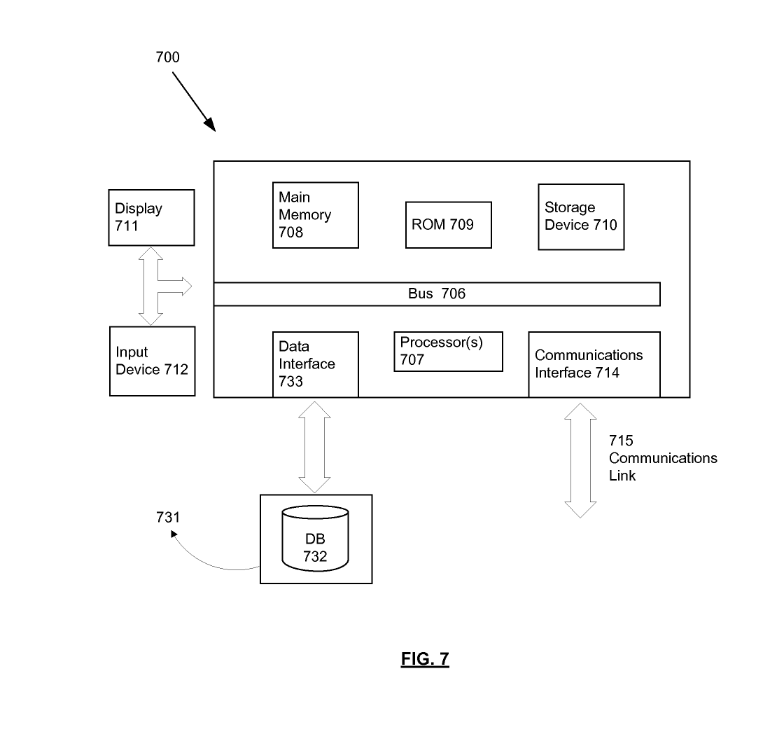

The execution of the sequences of instructions required to practice the embodiments can be performed by a computer system 700 as shown in FIG. 7. In an embodiment, execution of the sequences of instructions is performed by a single computer system 700. According to other embodiments, two or more computer systems 700 coupled by a communication link 715 can perform the sequence of instructions in coordination with one another. Although a description of only one computer system 700 will be presented below, however, it should be understood that any number of computer systems 700 can be employed to practice the embodiments.

A computer system 700 according to an embodiment will now be described with reference to FIG. 7, which is a block diagram of the functional components of a computer system 700. As used herein, the term computer system 700 is broadly used to describe any computing device that can store and independently run one or more programs.

Each computer system 700 can include a communication interface 714 coupled to the bus 706. The communication interface 714 provides two-way communication between computer systems 700. The communication interface 714 of a respective computer system 700 transmits and receives electrical, electromagnetic or optical signals, that include data streams representing various types of signal information, e.g., instructions, messages and data. A communication link 715 links one computer system 700 with another computer system 700. For example, the communication link 715 can be a LAN, in which case the communication interface 714 can be a LAN card, or the communication link 715 can be a PSTN, in which case the communication interface 714 can be an integrated services digital network (ISDN) card or a modem, or the communication link 715 can be the Internet, in which case the communication interface 714 can be a dial-up, cable or wireless modem.

A computer system 700 can transmit and receive messages, data, and instructions, including program, i.e., application, code, through its respective communication link 715 and communication interface 714. Received program code can be executed by the respective processor(s) 707 as it is received, and/or stored in the storage device 710, or other associated non-volatile media, for later execution.

In an embodiment, the computer system 700 operates in conjunction with a data storage system 731, e.g., a data storage system 731 that contains a database 732 that is readily accessible by the computer system 700. The computer system 700 communicates with the data storage system 731 through a data interface 733. A data interface 733, which is coupled to the bus 706, transmits and receives electrical, electromagnetic or optical signals, that include data streams representing various types of signal information, e.g., instructions, messages and data. In embodiments, the functions of the data interface 733 can be performed by the communication interface 714.

Computer system 700 includes a bus 706 or other communication mechanism for communicating instructions, messages and data, collectively, information, and one or more processors 707 coupled with the bus 706 for processing information. Computer system 700 also includes a main memory 708, such as a random access memory (RAM) or other dynamic storage device, coupled to the bus 706 for storing dynamic data and instructions to be executed by the processor(s) 707. The main memory 708 also can be used for storing temporary data, i.e., variables, or other intermediate information during execution of instructions by the processor(s) 707.

The computer system 700 can further include a read only memory (ROM) 709 or other static storage device coupled to the bus 706 for storing static data and instructions for the processor(s) 707. A storage device 710, such as a magnetic disk or optical disk, can also be provided and coupled to the bus 706 for storing data and instructions for the processor(s) 707.

A computer system 700 can be coupled via the bus 706 to a display device 711, such as, but not limited to, a cathode ray tube (CRT) or a liquid-crystal display (LCD) monitor, for displaying information to a user. An input device 712, e.g., alphanumeric and other keys, is coupled to the bus 706 for communicating information and command selections to the processor(s) 707.

According to one embodiment, an individual computer system 700 performs specific operations by their respective processor(s) 707 executing one or more sequences of one or more instructions contained in the main memory 708. Such instructions can be read into the main memory 708 from another computer-usable medium, such as the ROM 709 or the storage device 710. Execution of the sequences of instructions contained in the main memory 708 causes the processor(s) 707 to perform the processes described herein. In alternative embodiments, hard-wired circuitry can be used in place of or in combination with software instructions. Thus, embodiments are not limited to any specific combination of hardware circuitry and/or software.

The term “computer-usable medium,” as used herein, refers to any medium that provides information or is usable by the processor(s) 707. Such a medium can take many forms, including, but not limited to, non-volatile, volatile and transmission media. Non-volatile media, i.e., media that can retain information in the absence of power, includes the ROM 709, CD ROM, magnetic tape, and magnetic discs. Volatile media, i.e., media that can not retain information in the absence of power, includes the main memory 708. Transmission media includes coaxial cables, copper wire and fiber optics, including the wires that comprise the bus 706. Transmission media can also take the form of carrier waves; i.e., electromagnetic waves that can be modulated, as in frequency, amplitude or phase, to transmit information signals. Additionally, transmission media can take the form of acoustic or light waves, such as those generated during radio wave and infrared data communications.

In the foregoing specification, the embodiments have been described with reference to specific elements thereof. It will, however, be evident that various modifications and changes can be made thereto without departing from the broader spirit and scope of the embodiments. For example, the reader is to understand that the specific ordering and combination of process actions shown in the process flow diagrams described herein is merely illustrative, and that using different or additional process actions, or a different combination or ordering of process actions can be used to enact the embodiments. The specification and drawings are, accordingly, to be regarded in an illustrative rather than restrictive sense.

It should also be noted that the present invention can be implemented in a variety of computer systems. The various techniques described herein can be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language can be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system can also be considered to be implemented as a computer-readable storage medium, configured with a computer program, where the storage medium so configured causes a computer to operate in a specific and predefined manner. Further, the storage elements of the exemplary computing applications can be relational or sequential (flat file) type computing databases that are capable of storing data in various combinations and configurations.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A platform for alternative risk transfer (ART), comprising:
a risk database configured to store risk data;
a participant database configured to store a registry of ART participants;
a ratings database configured to store ratings data regarding said risk data and said ART participants; and
a risk crossing network database configured to store loss financing offers submitted by said ART participants, each of said loss financing offers being associated with one or more criteria.

2. The platform of claim 1, further comprising:
a loss financing tool configured to receive one of said loss financing offers from one of said ART participants and to pass said one of said loss financing offers to said risk crossing network database.

3. The platform of claim 1, further comprising:
an optimization engine configured to search for matching ones of said loss financing offers stored in said risk crossing network database that match one or more of said criteria.

4. The platform of claim 3, wherein said optimization engine sorts said matching ones of said loss financing offers according to one or more instances of said ratings data.

5. A method of matching alternative risk transfer (ART) participants, comprising:
receiving a plurality of loss financing offers from ART participants, each of said plurality of loss financing offers being associated with one or more criteria;
storing said plurality of loss financing offers in electronic memory at a risk crossing network database;
searching said risk crossing network database with an optimization engine for one or more matches within said plurality of loss financing offers, said matches being loss financing offers that share one or more criteria;
accepting one of said matches; and
transferring risk from a first ART participant to a second ART participant according to terms of the accepted one of said matches.

6. The method of claim 5, further comprising setting up a risk instrument to transfer said risk from said first ART participant to said second ART participant.

7. The method of claim 5, wherein accepting one of said matches comprises selecting from said one or more matches the matching loss financing offers that are rated the highest according to ratings data stored in a ratings database.

8. The method of claim 5, wherein accepting one of said matches comprises selecting from said one or more matches the matching loss financing offers that are best matched according to searching parameters specified by said first ART participant and said second ART participant.

9. The method of claim 5, further comprising storing a plurality of instances of risk data in a risk database.

10. The method of claim 9, wherein said plurality of instances of risk data are accessible to any of said ART participants to evaluate risk models in relation to basis risk or events.

11. The method of claim 9, wherein said plurality of instances of risk data are accessible to any of said ART participants to evaluate exposure of risk portfolios.

12. The method of claim 9, wherein said plurality of instances of risk data are converted into data streams for risk instruments classified by an accounting standard.

13. The method of claim 12, wherein said accounting standard is selected from the group consisting of Statutory Accounting Principles (SAP), Generally Accepted Accounting Principles (GAAP), and International Financial Reporting Standards (IFRS).

14. The method of claim 9, wherein said plurality of instances of risk data are accessible to any of said ART participants to determine whether a risk instrument is a reinsurance contract or a financial derivative.

15. The method of claim 14, wherein whether said risk instrument is a reinsurance contract or a financial derivative determines whether said risk instrument has an indemnity-based trigger.

16. The method of claim 9, wherein said plurality of instances of risk data are accessible to any of said ART participants to calculate a premium index, a claims index, and a retention rate for a regulatory scheme.

17. The method of claim 16, wherein said regulatory scheme is selected from the group consisting of Solvency I, Solvency II, Basel I, Basel II, and Basel III.

18. The method of claim 9, wherein said plurality of instances of risk data are accessible to any of said ART participants to perform cost-benefit analysis on one or more risk instruments.
